(19) United States
(12) Patent Application Publication
(10) Pub. No.: US 2025/0242666 A1
(43) Pub. Date: Jul. 31, 2025

(54) MANIFOLD FLUID MODULE

(71) Applicant: Hanon Systems, Daejeon (KR)

(72) Inventors: Hae Jun Lee, Daejeon (KR); In Guk Hwang, Daejeon (KR); Sang Yong Rhee, Daejeon (KR); Sung Je Lee, Daejeon (KR)

(21) Appl. No.: 18/837,207

(22) PCT Filed: May 16, 2023
(86) PCT No.: PCT/KR2023/006590

§ 371 Date: Aug. 9, 2024

(30) Foreign Application Priority Data
May 23, 2022 (KR) 10-2022-0062747
May 23, 2022 (KR) 10-2022-0062748

(51) Int. Cl. B60H 1/32; B60L 58/26

(52) U.S. Cl. CPC B60H 1/3229; B60H 1/3227; B60L 58/26

(57) ABSTRACT

The present invention relates to a manifold fluid module. A manifold fluid module according to an embodiment of the present invention may include a manifold plate comprising fluid passages formed internally, a first heat exchanger coupled to the manifold plate and configured to exchange heat between a first fluid and a second fluid, a second heat exchanger coupled to the manifold plate configured to exchange heat between the first fluid discharged from the first heat exchanger and the second fluid, and a plurality of valves configured to control expansion or direction of the first fluid entering the first heat exchanger or the second heat exchanger, wherein the plurality of valves may be clustered on an upper part of the manifold plate.

### TECHNICAL FIELD

The present invention relates to a manifold fluid module, and more particularly, to a manifold fluid module that integrates components such as heat exchangers and valves into a single unit.

### BACKGROUND ART

Amidst the growing emphasis on environmentally friendly industrial development and the pursuit of energy sources to replace fossil fuels, electric vehicles and hybrid vehicles have emerged as the most prominent areas of interest in the automotive industry. Both electric vehicles and hybrid vehicles are equipped with batteries to provide driving power, and these batteries are also utilized for heating and cooling purposes in addition to driving operations.

In vehicles that rely on batteries for propulsion, using the battery as a heat source for heating and cooling inevitably leads to a reduction in driving range; to address this issue, the integration of heat pump systems, which have been widely employed in residential heating and cooling systems, into automobiles has been proposed.

Essentially, a heat pump operates by absorbing low-temperature heat and transferring it to a higher temperature. For example, a heat pump cycle involves a liquid fluid evaporating in an evaporator, absorbing heat from its surroundings and becoming a gas, then releasing heat to its surroundings through a condenser and becoming liquid again. Applying this principle to electric or hybrid vehicles offers the advantage of providing a supplementary heat source that is absent in conventional air conditioning systems.

Current electric vehicle heat pump systems employ a partial modularization approach where key components (valves, accumulators, chillers, condensers, internal heat exchangers, sensors, etc.) are connected by piping, requiring separate fittings and connectors for these connections and resulting in necessary spacing between components. These factors lead to drawbacks in terms of packaging, cost, and workability.

Moreover, the incomplete modularity and integration introduce performance degradation issues due to the increase in unnecessary flow distance during the transition between cooling and heating modes.

### DISCLOSURE

### Technical Problem

An embodiment of the present invention aims to provide a manifold fluid module capable of reducing costs and weight and improve workability by utilizing a manifold plate that performs the functions of piping, fittings, and housing.

In addition, an embodiment of the present invention aims to provide a manifold fluid module capable of optimizing the module package by allowing the flow of fluid to naturally form from top to bottom.

In addition, an embodiment of the present invention aims to provide a manifold fluid module capable of minimizing thermal interference between refrigerants and improving heat pump performance by separating the high-temperature and low-temperature regions of the fluid when operating in air conditioning mode.

### Technical Solution

A manifold fluid module according to an embodiment of the present invention may include a manifold plate comprising fluid passages formed internally, a first heat exchanger coupled to the manifold plate and configured to exchange heat between a first fluid and a second fluid, a second heat exchanger coupled to the manifold plate configured to exchange heat between the first fluid discharged from the first heat exchanger and the second fluid, and a plurality of valves configured to control expansion or direction of the first fluid entering the first heat exchanger or the second heat exchanger, wherein the plurality of valves may be clustered on an upper part of the manifold plate.

The first heat exchanger may be arranged on one side of the manifold plate, and the second heat exchanger may be arranged laterally to the first heat exchanger.

The plurality of valves may include a first expansion valve configured to expand the first fluid entering the first heat exchanger, and a second expansion valve configured to expand the first fluid entering the second heat exchanger, the first expansion valve being arranged above the first heat exchanger, the second expansion valve being arranged above the second heat exchanger, the first fluid entering the first and second heat exchangers moving from the top to the bottom.

The plurality of valves may include a first direction switching valve and a second direction switching valve configured to control the direction of the first fluid discharged from the first heat exchanger, the first direction switching valve and the second direction switching valve being clustered above the second heat exchanger.

The first expansion valve, first direction switching valve, second direction switching valve, and second expansion valve may be arranged on the upper part of the manifold plate, the first heat exchanger may be arranged on one side of the lower part of the manifold plate, and the second heat exchanger may be arranged on the other side of the lower part of the manifold plate.

The first heat exchanger, first expansion valve, first direction switching valve, and second direction switching valve may be arranged on one side of an imaginary reference line formed on the manifold plate, and the second heat exchanger and second expansion valve may be arranged on the other side.

The manifold plate may be divided by an imaginary reference line into a high-temperature zone where the first fluid at a high temperature flows through the first heat exchanger and a low-temperature zone where the first fluid at a low temperature flows through the second heat exchanger.

The first heat exchanger may include a first fluid port for inlet and outlet of the first fluid and a second fluid port for inlet and outlet of the second fluid, the first fluid port and the second fluid port being separately arranged.

The first fluid port may include a first inlet port where the first fluid is introduced and a first outlet port where the first fluid is discharged, the first outlet port being formed on one side close to the first expansion valve or the second expansion valve, the first outlet port being formed on the other side father away from the first expansion valve or the second expansion valve.

The first heat exchanger may be a water-cooled condenser, and the second heat exchanger may be a chiller.

A manifold fluid module according to another embodiment of the present invention may include a manifold plate comprising fluid passages formed internally, a first heat exchanger coupled to the manifold plate and configured to exchange heat between a first fluid and a second fluid, and a second heat exchanger coupled to the manifold plate configured to exchange heat between the first fluid discharged from the first heat exchanger and the second fluid, wherein the first heat exchanger may be arranged vertically, and the second heat exchanger may be arranged horizontally on the manifold plate.

The first heat exchanger may be arranged on one side of the manifold plate, and the second heat exchanger may be arranged laterally to the first heat exchanger.

The manifold fluid module may further include a first expansion valve configured to expand the first fluid entering the first heat exchanger, and a second expansion valve configured to expand the first fluid entering the second heat exchanger, wherein the first expansion valve may be arranged above the first heat exchanger, the second expansion valve may be arranged above the second heat exchanger, and the first fluid entering the first and second heat exchangers may move from the top to the bottom.

The manifold fluid module may further include a first direction switching valve and a second direction switching valve configured to control the direction of the first fluid discharged from the first heat exchanger, wherein the first direction switching valve may be arranged below the second heat exchanger, and the second direction switching valve may be arranged above the second heat exchanger.

The first expansion valve, the second direction switching valve, and the second expansion valve may be arranged on the upper part of the manifold plate, the first heat exchanger may be arranged on one side of the lower part of the manifold plate, and the second heat exchanger and the first direction switching valve may be arranged on the other side of the lower part of the manifold plate.

The first heat exchanger, first expansion valve, first direction switching valve, and second direction switching valve may be arranged on one side of an imaginary reference line formed on the manifold plate, and the second heat exchanger and second expansion valve may be arranged on the other side.

The manifold plate may be divided by an imaginary reference line into a high-temperature zone where the first fluid at a high temperature flows through the first heat exchanger and a low-temperature zone where the first fluid at a low temperature flows through the second heat exchanger.

The first heat exchanger may include a first fluid port for inlet and outlet of the first fluid and a second fluid port for inlet and outlet of the second fluid, the first fluid port and the second fluid port being separately arranged.

The first fluid port may include a first inlet port where the first fluid is introduced and a first outlet port where the first fluid is discharged, the first outlet port being formed on one side close to the first expansion valve or the second expansion valve, the first outlet port being formed on the other side father away from the first expansion valve or the second expansion valve.

The first heat exchanger may be a water-cooled condenser, and the second heat exchanger may be a chiller.

### Advantageous Effects

An embodiment of the present invention is advantageous in terms of reducing costs and weight and improve workability by utilizing a manifold plate that performs the functions of piping, fittings, and housing.

In addition, an embodiment of the present invention is advantageous in terms of optimizing the module package by allowing the flow of fluid to naturally form from top to bottom.

In addition, an embodiment of the present invention is advantageous in terms of minimizing thermal interference between refrigerants and improving heat pump performance by separating the high-temperature and low-temperature regions of the fluid when operating in air conditioning mode.

### DESCRIPTION OF DRAWINGS

FIG. 1 is a perspective view illustrating the front side of a manifold fluid module according to an embodiment of the present invention;

FIG. 2 is a perspective view illustrating the rear of a manifold fluid module according to an embodiment of the present invention;

FIG. 3 is a diagram illustrating the flow of fluid in air conditioning mode according to an embodiment of the present invention;

FIG. 4 is a diagram illustrating the flow of fluid in heat pump mode according to an embodiment of the present invention;

FIG. 5 is a perspective view illustrating the front of a manifold fluid module according to another embodiment of the present invention;

FIG. 6 is a perspective view illustrating the rear of a manifold fluid module according to another embodiment of the present invention;

FIG. 7 is a diagram illustrating the flow of fluid in air conditioning mode according to another embodiment of the present invention; and

FIG. 8 is a diagram illustrating the flow of fluid in heat pump mode according to another embodiment of the present invention.

### MODE FOR INVENTION

While the present invention admits various modifications, the following detailed descriptions and drawings focus on preferred embodiments for clarity. However, such embodiments are not intended to limit the invention and it should be understood that the embodiments encompass all modifications, equivalents, and alternatives within the spirit and scope of the invention. Detailed descriptions of well-known technologies may be omitted to avoid obscuring the subject matter of the present invention.

Terms such as “first,” “second,” etc. may be used to describe various components, but the components should not be limited by these terms. The terms are used only for distinguishing one component from another component.

The terminology used in this application is employed merely to describe specific embodiments and is not intended to limit the scope of the present invention. The singular forms are intended to include the plural forms as well unless the context clearly indicates otherwise. In this application, terms such as “comprising” or “having” indicate the presence of the features, numbers, steps, operations, components, or parts listed in the specification, without excluding the presence or possibility of one or more other features, numbers, steps, operations, components, or parts or their combinations.

Throughout the specification, the term “connected” not only means that two or more components are directly connected but also includes indirect connections via intermediary components, electrical connections, and instances where components are referred to by different names based on their position or function but are considered as a whole.

Hereinafter, a description is made of the manifold fluid module according to an embodiment of the present invention with reference to accompanying drawing, where identical or corresponding components are assigned the same reference numerals and repetitive descriptions are omitted.

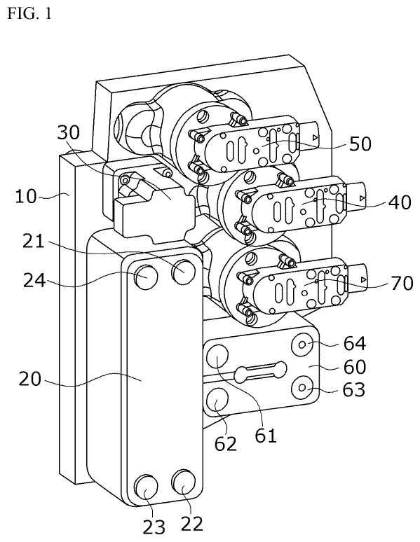

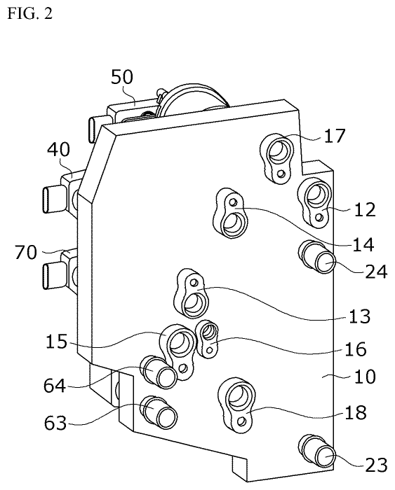

FIG. 1 is a perspective view illustrating the front side of a manifold fluid module according to an embodiment of the present invention, and FIG. 2 is a perspective view illustrating the rear of a manifold fluid module according to an embodiment of the present invention.

As shown in the drawings, a manifold fluid module according to an embodiment of the present invention may include a manifold plate 10 forming fluid passages inside, a first heat exchanger 20 coupled to the manifold plate 10 for exchanging heat between a first fluid and a second fluid, a second heat exchanger 60 coupled to the manifold plate 10 for exchanging heat between the first fluid discharged from the first heat exchanger 20 and the second fluid, and a plurality of Valves 30, 40, 50, and 60 for controlling the expansion of the first fluid entering the first heat exchanger 20 or the second heat exchanger 60 or for controlling the direction of the first fluid.

The manifold plate 10 is generally formed with fluid passages recessed into its interior and has a plate shape with a predetermined thickness. The manifold plate 10 may be modularized by combining the first heat exchanger 20, the second heat exchanger 60, the expansion valve 30 and 70, and the direction switching valve 40 and 50 of the heat pump system, thereby reducing the number of manufacturing steps and assembly line steps for vehicles. In addition, the manifold plate 10 may reduce costs and improve workability by performing the functions of piping, fittings, and housing at the same time.

The assembly of the manifold plate 10 includes top and bottom sections, allowing production through a method using brazing, structural adhesives, gaskets, or the like. The material for the manifold plate 10 may vary depending on the application and function, such as aluminum, thermoplastic materials, or stainless steel, chosen according to specific needs.

With reference to FIG. 2, a fluid inlet port 12 is provided on the back of the manifold plate 10 into which high-temperature, high-pressure gaseous fluid discharged from a compressor or internal condenser is introduced, and fluid passages may be formed on the back of the manifold plate 10 to guide the movement of the fluid for heat exchange, expansion, inflow, and discharge.

Various fluid ports for inflow and discharge of fluid may also be provided on the back of the manifold plate 10. in this embodiment, the manifold plate 10 includes an external heat Exchanger inlet port 13 for the first fluid to enter from an external heat exchanger (not shown) and an external heat exchanger outlet port 14 for the first fluid to be discharged to the external heat exchanger. The manifold plate 10 may also include an evaporator inlet port 15 for the first fluid to enter from the evaporator (not shown), an evaporator outlet port 16 for the first fluid to exit, a dehumidification evaporator outlet port 17 for the first fluid to be discharged during dehumidification, and an accumulator port 18 for the first fluid discharged from the second heat exchanger 60 to enter the accumulator (not shown).

With reference back to FIG. 1, the manifold plate 10 integrates the first heat exchanger 20 and the second heat exchanger 60 as heat exchange devices. The first heat exchanger 20 and the second heat exchanger 60 allow the first fluid and the second fluid to pass through, exchanging heat therebetween.

In this embodiment, the first heat exchanger 20 may be a water-cooled condenser, and the second heat exchanger 60 may be a chiller. A water-cooled condenser serves to exchange heat between the high-temperature, high-pressure gaseous fluid (refrigerant) discharged from a compressor or internal condenser with an external heat source, thereby condensing the fluid into a high-pressure liquid. A chiller is a device for heat exchange between a low-temperature, low-pressure fluid supplied thereto and a fluid (coolant) circulating in a coolant circulation line (not shown), and the chilled coolant resulting from the heat exchange in the chiller circulates through the coolant circulation line and then used to exchange heat with a battery.

While various fluids such as refrigerants and coolants can be employed as the first and second fluids, this embodiment employs refrigerant as the first fluid and coolant as the second fluid.

The first heat exchanger 20 is equipped with first fluid ports for the inlet and outlet of the first fluid. The first fluid ports include a first inlet port 21 and a first outlet port 22, which are respectively provided at the top and bottom of the first heat exchanger 20. The first inlet port 21 serves as the entry point of the first fluid passed through the first expansion valve 30, while the first outlet port 22 serves as the exit point of the first fluid after heat exchange in the first heat exchanger 20. The first inlet port 21 and the first outlet port 22 may be formed at the top and bottom of the first heat exchanger 20 in the form of a hole.

In this case, considering thermal interference, the first inlet port 21 may be formed on one side close to the first expansion valve 30, and the first outlet port 22 may be formed on the opposite side, farther away from the first expansion valve 30. In more detail, the first inlet port 21 may be positioned closer to the first expansion valve 30 relative to the first outlet port 22. That is, the distance from the first expansion valve 30 to the first inlet port 21 may be shorter than the distance from the first expansion valve 30 to the first outlet port 22.

The first heat exchanger 20 is also equipped with second fluid ports for the inlet and outlet of the second fluid. The second fluid ports include a second inlet port 23 and a second outlet port 24, which are respectively provided at the bottom and top of the first heat exchanger 20. The second inlet port 23 serves as the entry point of the second fluid, while the second outlet port 24 serves as the exit point of the second fluid after heat exchange with the first fluid. The second fluid flows in the opposite direction (bottom to top) compared to the first fluid, while undergoing heat exchange with the first fluid.

The separation between the first fluid ports and the second fluid ports, as described above, is capable of enhancing the assembly efficiency of the first fluid piping and the second fluid piping.

The first expansion valve 30 regulates the expansion of refrigerant entering the first heat exchanger 20. The first expansion valve 30 may be positioned at the top of the first heat exchanger 20 and may control the expansion or passage of the first fluid entering through the fluid inlet port 12. The first fluid entering through the first expansion valve 30 may pass through the first heat exchanger 20, undergoing heat exchange, or proceed to move to an external heat exchanger.

The first fluid discharged through the first outlet port 22 of the first heat exchanger 20 flows into the first direction switching valve 40. The first direction switching valve 40 controls the direction of the first fluid discharged from the first heat exchanger 20. The first fluid, which passes through the first direction switching valve 40 and enters the second direction switching valve 50, may flow to the evaporator or an external heat exchanger. Here, the first fluid may move to the external heat exchanger through the external heat exchanger inlet port 13 and the external heat exchanger outlet port 14, and may also move to the evaporator through the evaporator inlet port 15 and the evaporator outlet port 16.

The first fluid entering through the first expansion valve 30 may move to the evaporator after passing through the second direction switching valve 50 in dehumidification mode.

The second heat exchanger 60 is supplied with a low-temperature, low-pressure fluid for heat exchange with the coolant circulating in the coolant circulation line (not shown). The chilled coolant, which has undergone heat exchange in the second heat exchanger 60, may circulate through the coolant circulation line for heat exchange with the battery. The first fluid, after undergoing heat exchange with the external heat exchanger, flows into the second expansion valve 70 and, after being expanded in the second expansion valve 70, flows into the second heat exchanger 60. The first fluid, after undergoing heat exchange in the second heat exchanger 60, is discharged through the bottom and flows into the accumulator (not shown).

To facilitate this process, the second heat exchanger 60 is equipped with first fluid ports for the inlet and outlet of the first fluid. The first fluid ports include a first inlet port 61 and a first outlet port 62, which are respectively provided at the top and bottom of the second heat exchanger 60. The first inlet port 61 serves as the entry point of the first fluid, while the first outlet port 62 serves as the exit point of the first fluid after heat exchange in the second heat exchanger 60. The first inlet port 61 and the first outlet port 62 may be formed at the top and bottom of the second heat exchanger 60 in the form of a hole.

In this case, considering thermal interference, the first inlet port 61 of the second heat exchanger 60 may be formed on one side close to the first expansion valve 70, and the first outlet port 62 may be formed on the opposite side, farther away from the first expansion valve 70. In more detail, the first inlet port 61 may be positioned closer to the second expansion valve 70 relative to the first outlet port 62. That is, the distance from the second expansion valve 70 to the first inlet port 61 may be shorter than the distance from the second expansion valve 70 to the first outlet port 62.

The second heat exchanger 60 is also equipped with second fluid ports for the inlet and outlet of the second fluid. The second fluid ports include a second inlet port 63 and a second outlet port 64, which are respectively provided at the bottom and top of the second heat exchanger 60. The second inlet port 63 serves as the entry point of the second fluid, while the second outlet port 64 serves as the exit point of the second fluid after heat exchange with the first fluid. The second fluid flows in the opposite direction (bottom to top) compared to the first fluid, while undergoing heat exchange with the first fluid.

With reference back to FIG. 1, in this embodiment, the first expansion valve 30, the first direction switching valve 40, the second direction switching valve 50, and the second expansion valve 70 may be arranged on the upper part of the manifold plate 10, the first heat exchanger 20 may be arranged on one side of the lower part of the manifold plate 10, and the second heat exchanger 60 may be arranged on the other side of the lower part of the manifold plate 10.

In this embodiment, the valves that control the expansion or direction of the first fluid are clustered on the upper and central parts of the manifold plate 10, considering the thickness of the valves themselves, and such clustering facilitates manufacturing in processes such as forging. That is, arranging the valve components on the manifold plate 10 allows for optimal placement of the components in minimal space, thereby maximizing spatial efficiency, and the overall top-to-bottom formation of the fluid flow optimizes the fluid flow as well.

In particular, the first heat exchanger 20 is arranged vertically on one side of the lower part of the manifold plate 10, and the second heat exchanger 60 is arranged horizontally on the other side of the lower part of the manifold plate 10, thereby optimizing the fluid module package. That is, the second heat exchanger 60 is arranged laterally to the first heat exchanger 20, thereby enhancing space efficiency. Additionally, the first expansion valve 30 is positioned above the first heat exchanger 20, and the second expansion valve 70 is positioned above the second heat exchanger 60, allowing the flow of the first fluid to naturally form from top to bottom.

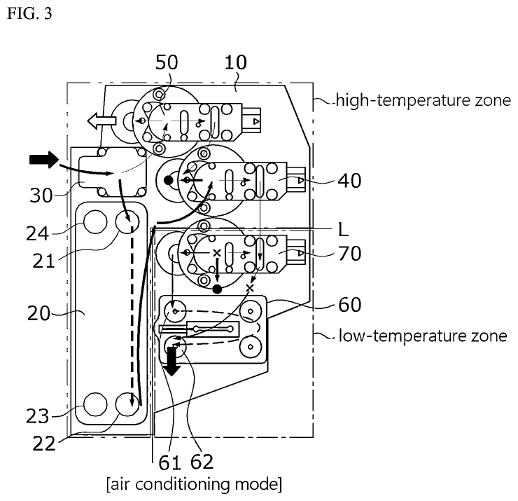

With reference to FIG. 3, an imaginary reference line 1 on the manifold plate 10 facilitates the arrangement of the first heat exchanger 20, first expansion valve 30, first directional switching valve 40, and second direction switching valve 50 on one side, while the second heat exchanger 60 and second expansion valve 70 may be placed on the other side.

In more detail, the imaginary reference line I divides the manifold plate 10 into a high-temperature zone for the high-temperature first fluid flowing and a low-temperature zone for the low-temperature first fluid during air conditioning mode. Components for the high-temperature first fluid movement may be arranged in the high-temperature zone, while components for the low-temperature first fluid movement may be arranged in the low-temperature zone. This configuration is capable of minimizing the thermal interference between the first fluid in high and low temperature conditions and improve the performance of the heat pump system.

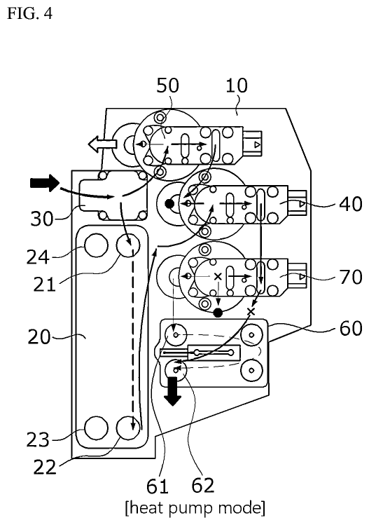

FIG. 3 is a diagram illustrating the flow of fluid in air conditioning mode according to an embodiment of the present invention, and FIG. 4 is a diagram illustrating the flow of fluid in heat pump mode according to an embodiment of the present invention.

With reference to FIG. 3, in air conditioning mode, the first fluid entering through the fluid inlet port 12 from the compressor or internal condenser passes through the open first expansion valve 30, enters the top of the first heat exchanger 20, and then moves to the bottom. The first fluid discharged through the first outlet port 22 of the first heat exchanger 20 flows into the first direction switching valve 40.

The first fluid entering the first direction switching valve 40 is introduced into the second direction switching valve 50 located above and then moves to the external heat exchanger.

Meanwhile, the first fluid entering the second expansion valve 70 is introduced into the second heat exchanger 60 and exchanges heat with the coolant circulating in the coolant circulation line. The chilled coolant, which has undergone heat exchange in the second heat exchanger 60, may circulate through the coolant circulation line for heat exchange with the battery. The first fluid discharged from the bottom of the second heat exchanger 60 is guided to the accumulator port 18 and introduced into the accumulator (not shown), where the first fluid is separated into gas and liquid phases; the gaseous phase is introduced into the compressor and then the first fluid circulates through the heat pump system.

In dehumidification mode, the first fluid flows from the first expansion valve 30 to the second direction switching valve 50 and may be discharged to the evaporator.

With reference to FIG. 4, in heat pump mode, the first fluid entering through the fluid inlet port 12 expands through the first expansion valve 30 and may flow into the first heat exchanger 20 and the second direction switching valve 50.

The first fluid entering the second direction switching valve 50 may be introduced to the external heat exchanger, and the first fluid passed through the first heat exchanger 20 may be introduced to the first direction switching valve 40. The first fluid entering from the external heat exchanger to the second expansion valve 70 is discharged through the accumulator port 18 and moves to the accumulator.

In dehumidification mode, the first fluid entering the second expansion valve 70 undergoes heat exchange in the second heat exchanger 60 and discharged to the accumulator through the accumulator port 18.

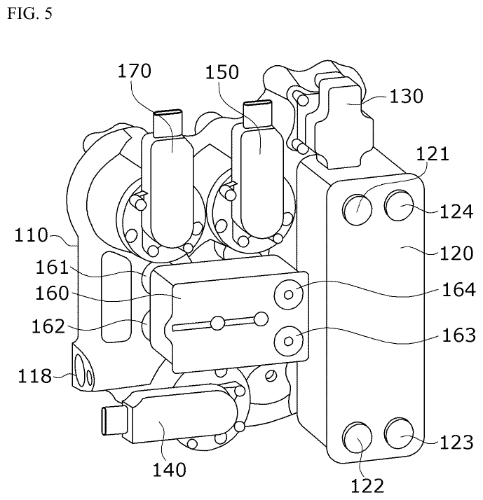

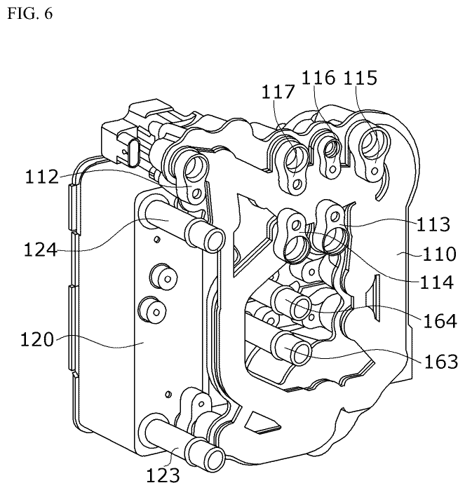

FIG. 5 is a perspective view illustrating the front of a manifold fluid module according to another embodiment of the present invention, and FIG. 6 is a perspective view illustrating the rear of a manifold fluid module according to another embodiment of the present invention.

As shown in the drawings, a manifold fluid module according to another embodiment of the present invention may include a manifold plate 110 forming fluid passages inside, a first heat exchanger 120 coupled to the manifold plate 110 for exchanging heat between a first fluid and a second fluid, a second heat exchanger 160 coupled to the manifold plate 110 for exchanging heat between the first fluid discharged from the first heat exchanger 120 and the second fluid.

The manifold plate 110 is generally formed with fluid passages recessed into its interior and has a plate shape with a predetermined thickness. The manifold plate 110 may be modularized by combining the first heat exchanger 120, the second heat exchanger 160, the expansion valve 130 and 170, and the direction switching valve 140 and 150 of the heat pump system, thereby reducing the number of manufacturing steps and assembly line steps for vehicles. In addition, the manifold plate 110 may reduce costs and improve workability by performing the functions of piping, fittings, and housing at the same time.

The assembly of the manifold plate 110 includes top and bottom sections, allowing production through a method using brazing, structural adhesives, gaskets, or the like. The material for the manifold plate 110 may vary depending on the application and function, such as aluminum, thermoplastic materials, or stainless steel, chosen according to specific needs.

With reference to FIG. 6, a fluid inlet port 112 is provided on the back of the manifold plate 110 into which high-temperature, high-pressure gaseous fluid discharged from a compressor or internal condenser is introduced, and fluid passages may be formed on the back of the manifold plate 110 to guide the movement of the fluid for heat exchange, expansion, inflow, and discharge.

Various fluid ports for inflow and discharge of fluid may also be provided on the back of the manifold plate 110. In this embodiment, the manifold plate 10 includes an external heat exchanger inlet port 113 for the first fluid to enter from an external heat exchanger (not shown) and an external heat exchanger outlet port 114 for the first fluid to be discharged to the external heat exchanger. The manifold plate 10 may also include an evaporator inlet port 115 for the first fluid to enter from the evaporator (not shown), an evaporator outlet port 116 for the first fluid to exit, a dehumidification evaporator outlet port 117 for the first fluid to be discharged during dehumidification, and an accumulator port 118 for the first fluid discharged from the second heat exchanger 160 to enter the accumulator (not shown).

With reference back to FIG. 5, the manifold plate 110 integrates the first heat exchanger 120 and the second heat exchanger 160 as heat exchange devices. The first heat exchanger 120 and the second heat exchanger 160 allow the first fluid and the second fluid to pass through, exchanging heat therebetween.

In this embodiment, the first heat exchanger 120 may be a water-cooled condenser, and the second heat exchanger 160 may be a chiller. A water-cooled condenser serves to exchange heat between the high-temperature, high-pressure gaseous fluid (refrigerant) discharged from a compressor or internal condenser with an external heat source, thereby condensing the fluid into a high-pressure liquid. A chiller is a device for heat exchange between a low-temperature, low-pressure fluid supplied thereto and a fluid (coolant) circulating in a coolant circulation line (not shown), and the chilled coolant resulting from the heat exchange in the chiller circulates through the coolant circulation line and then used to exchange heat with a battery.

While various fluids such as refrigerants and coolants can be employed as the first and second fluids, this embodiment employs refrigerant as the first fluid and coolant as the second fluid.

The first heat exchanger 120 is equipped with first fluid ports for the inlet and outlet of the first fluid. The first fluid ports include a first inlet port 121 and a first outlet port 122, which are respectively provided at the top and bottom of the first heat exchanger 120. The first inlet port 121 serves as the entry point of the first fluid passed through the first expansion valve 130, while the first outlet port 122 serves as the exit point of the first fluid after heat exchange in the first heat exchanger 120. The first inlet port 121 and the first outlet port 122 may be formed at the top and bottom of the first heat exchanger 120 in the form of a hole.

In this case, considering thermal interference, the first inlet port 121 may be formed on one side close to the first expansion valve 130, and the first outlet port 122 may be formed on the opposite side, farther away from the first expansion valve 130. In more detail, the first inlet port 121 may be positioned closer to the first expansion valve 130 relative to the first outlet port 122. That is, the distance from the first expansion valve 130 to the first inlet port 121 may be shorter than the distance from the first expansion valve 130 to the first outlet port 122.

The first heat exchanger 120 is also equipped with second fluid ports for the inlet and outlet of the second fluid. The second fluid ports include a second inlet port 123 and a second outlet port 124, which are respectively provided at the bottom and top of the first heat exchanger 120. The second inlet port 123 serves as the entry point of the second fluid, while the second outlet port 124 serves as the exit point of the second fluid after heat exchange with the first fluid. The second fluid flows in the opposite direction (bottom to top) compared to the first fluid, while undergoing heat exchange with the first fluid.

The separation between the first fluid ports and the second fluid ports, as described above, is capable of enhancing the assembly efficiency of the first fluid piping and the second fluid piping.

The first expansion valve 130 regulates the expansion of refrigerant entering the first heat exchanger 120. The first expansion valve 130 may be positioned at the top of the first heat exchanger 120 and may control the expansion or passage of the first fluid entering through the fluid inlet port 112. The first fluid entering through the first expansion valve 130 may pass through the first heat exchanger 120, undergoing heat exchange, or proceed to move to an external heat exchanger.

The first fluid discharged through the first outlet port 122 of the first heat exchanger 120 flows into the first direction switching valve 140. The first direction switching valve 140 controls the direction of the first fluid discharged from the first heat exchanger 120. The first fluid, which passes through the first direction switching valve 140 and enters the second direction switching valve 150, may flow to the evaporator or an external heat exchanger. Here, the first fluid may move to the external heat exchanger through the external heat exchanger inlet port 113 and the external heat exchanger outlet port 114, and may also move to the evaporator through the evaporator inlet port 115 and the evaporator outlet port 116.

The first fluid entering through the first expansion valve 130 may move to the evaporator after passing through the second direction switching valve 150 in dehumidification mode.

The second heat exchanger 160 is supplied with a low-temperature, low-pressure fluid for heat exchange with the coolant circulating in the coolant circulation line (not shown). The chilled coolant, which has undergone heat exchange in the second heat exchanger 160, may circulate through the coolant circulation line for heat exchange with the battery. The first fluid, after undergoing heat exchange with the external heat exchanger, flows into the second expansion valve 170 and, after being expanded in the second expansion valve 170, flows into the second heat exchanger 160. The first fluid, after undergoing heat exchange in the second heat exchanger 160, is discharged through the bottom and flows into the accumulator (not shown).

To facilitate this process, the second heat exchanger 160 is equipped with first fluid ports for the inlet and outlet of the first fluid. The first fluid ports include a first inlet port 161 and a first outlet port 162, which are respectively provided at the top and bottom of the second heat exchanger 160. The first inlet port 161 serves as the entry point of the first fluid, while the first outlet port 162 serves as the exit point of the first fluid after heat exchange in the second heat exchanger 160. The first inlet port 161 and the first outlet port 162 may be formed at the top and bottom of the second heat exchanger 160 in the form of a hole.

In this case, considering thermal interference, the first inlet port 161 of the second heat exchanger 160 may be formed on one side close to the second expansion valve 170, and the first outlet port 162 may be formed on the opposite side, farther away from the second expansion valve 170. In more detail, the first inlet port 161 may be positioned closer to the second expansion valve 170 relative to the first outlet port 162. That is, the distance from the second expansion valve 170 to the first inlet port 161 may be shorter than the distance from the second expansion valve 170 to the first outlet port 162.

The second heat exchanger 160 is also equipped with second fluid ports for the inlet and outlet of the second fluid. The second fluid ports include a second inlet port 163 and a second outlet port 164, which are respectively provided at the bottom and top of the second heat exchanger 160. The second inlet port 163 serves as the entry point of the second fluid, while the second outlet port 164 serves as the exit point of the second fluid after heat exchange with the first fluid. The second fluid flows in the opposite direction (bottom to top) compared to the first fluid, while undergoing heat exchange with the first fluid.

With reference back to FIG. 5, in this embodiment, the first expansion valve 130, the second direction switching valve 150, and the second expansion valve 170 may be arranged on the upper part of the manifold plate 110, the first heat exchanger 120 may be arranged on one side of the lower part of the manifold plate 110, and the second heat exchanger 160 and the first direction switching valve 140 may be arranged on the other side of the lower part of the manifold plate 110. Here, the first direction switching valve 140 may be positioned below the second heat exchanger 160, while the second direction switching valve 150 may be placed above the second heat exchanger 160.

That is, arranging the aforementioned components on the manifold plate 110 allows for optimal placement of the components in minimal space, thereby maximizing spatial efficiency, and the overall top-to-bottom formation of the fluid flow optimizes the fluid flow as well.

In particular, the first heat exchanger 120 is arranged vertically on one lower side of the manifold plate 110, and the second heat exchanger 160 is arranged horizontally on the other lower side of the manifold plate 110, thereby optimizing the fluid module package. That is, the second heat exchanger 160 is arranged laterally to the first heat exchanger 120, thereby enhancing space efficiency. Additionally, the first expansion valve 130 is positioned above the first heat exchanger 120, and the second expansion valve 170 is positioned above the second heat exchanger 160, allowing the flow of the first fluid to naturally form from top to bottom.

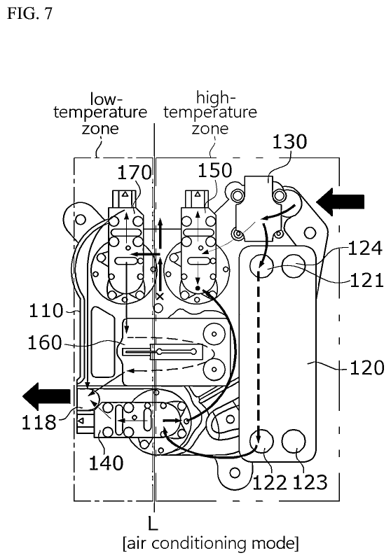

With reference to FIG. 7, an imaginary reference line 1 on the manifold plate 110 facilitates the arrangement of the first heat exchanger 120, first expansion valve 130, first directional switching valve 140, and second direction switching valve 150 on one side, while the second heat exchanger 160 and second expansion valve 170 may be placed on the other side.

In more detail, the imaginary reference line I divides the manifold plate 10 into a high-temperature zone for the high-temperature first fluid flowing and a low-temperature zone for the low-temperature first fluid during air conditioning mode. Components for the high-temperature first fluid movement may be arranged in the high-temperature zone, while components for the low-temperature first fluid movement may be arranged in the low-temperature zone. This configuration is capable of minimizing the thermal interference between the first fluid in high and low temperature conditions and improve the performance of the heat pump system.

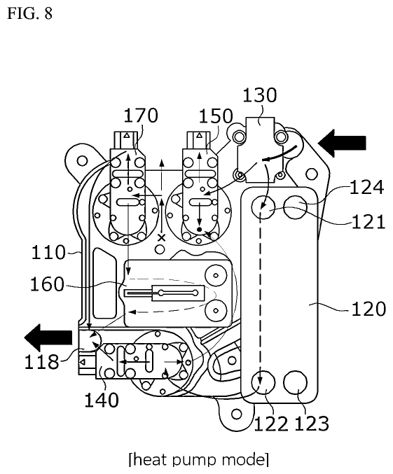

FIG. 7 is a diagram illustrating the flow of fluid in air conditioning mode according to another embodiment of the present invention, and FIG. 8 is a diagram illustrating the flow of fluid in heat pump mode according to another embodiment of the present invention.

With reference to FIG. 7, in air conditioning mode, the first fluid entering through the fluid inlet port 112 from the compressor or internal condenser passes through the open first expansion valve 130, enters the top of the first heat exchanger 120, and then moves to the bottom. The first fluid discharged through the first outlet port 122 of the first heat exchanger 120 flows into the first direction switching valve 140.

The first fluid entering the first direction switching valve 140 is introduced into the second direction switching valve 150 located above and then moves to the external heat exchanger.

Meanwhile, the first fluid entering the second expansion valve 170 is introduced into the second heat exchanger 160 and exchanges heat with the coolant circulating in the coolant circulation line. The chilled coolant, which has undergone heat exchange in the second heat exchanger 160, may circulate through the coolant circulation line for heat exchange with the battery. The first fluid discharged from the bottom of the second heat exchanger 160 is guided to the accumulator port 118 and introduced into the accumulator (not shown), where the first fluid is separated into gas and liquid phases; the gaseous phase is introduced into the compressor and then the first fluid circulates through the heat pump system.

In dehumidification mode, the first fluid flows from the first expansion valve 130 to the second direction switching valve 150 and may be discharged to the evaporator.

With reference to FIG. 8, in heat pump mode, the first fluid entering through the fluid inlet port 112 expands through the first expansion valve 130 and may flow into the first heat exchanger 120 and the second direction switching valve 150.

The first fluid entering the second direction switching valve 150 may be introduced to the external heat exchanger, and the first fluid passed through the first heat exchanger 120 may be introduced to the first direction switching valve 140. The first fluid entering the firs direction switching valve 140 is discharged to the accumulator through the accumulator port 118. The first fluid entering from the external heat exchanger to the second expansion valve 170 is discharged through the accumulator port 118 and moves to the accumulator.

In dehumidification mode, the first fluid entering the second expansion valve 170 undergoes heat exchange in the second heat exchanger 160 and discharged to the accumulator through the accumulator port 118.

While the foregoing description has focused on specific embodiments of the present invention, it should be understood that various modifications and changes can be made by those skilled in the art without departing from the spirit and scope of the invention as defined in the appended claims.

### Description of Reference Numerals

10: Manifold plate 12: Fluid inlet port
13: External heat exchanger inlet Port 14: External heat exchanger outlet port
15: Evaporator inlet Port 16: Evaporator output port
17: Dehumidification evaporator outlet Port 18: Accumulator port
20: First heat exchanger 21: First inlet port
22: First outlet Port 23: Second inlet port
24: Second output Port 30: First expansion valve
40: First direction switching valve 50: Second direction switching valve
60: Second heat exchanger 61: First inlet port
62: First outlet Port 63: Second inlet port
64: Second output Port 70: Second expansion valve
110: Manifold plate 112: Fluid inlet port
113: External heat exchanger inlet port 114: External heat exchanger outlet port
115: Evaporator inlet port 116: Evaporator output port
117: Dehumidification evaporator outlet port 118: Accumulator port
120: First heat exchanger 121: First inlet port
122: First outlet port 123: Second inlet port
124: Second output port 130: First expansion valve
140: First direction switching valve 150: Second direction switching valve
160: Second heat exchanger 161: First inlet port
162: First outlet port 163: Second inlet port
164: Second output port 170: Second expansion valve

1. A manifold fluid module comprising:
a manifold plate comprising fluid passages formed internally;
a first heat exchanger coupled to the manifold plate and configured to exchange heat between a first fluid and a second fluid;
a second heat exchanger coupled to the manifold plate configured to exchange heat between the first fluid discharged from the first heat exchanger and the second fluid; and
a plurality of valves configured to control expansion or direction of the first fluid entering the first heat exchanger or the second heat exchanger,
wherein the plurality of valves are clustered on an upper part of the manifold plate.

2. The manifold fluid module of claim 1, wherein the first heat exchanger is arranged on one side of the manifold plate, and the second heat exchanger is arranged laterally to the first heat exchanger.

3. The manifold fluid module of claim 1, wherein the plurality of valves comprise a first expansion valve configured to expand the first fluid entering the first heat exchanger, and a second expansion valve configured to expand the first fluid entering the second heat exchanger, the first expansion valve being arranged above the first heat exchanger, the second expansion valve being arranged above the second heat exchanger, the first fluid entering the first and second heat exchangers moving from the top to the bottom.

4. The manifold fluid module of claim 3, wherein the plurality of valves comprise a first direction switching valve and a second direction switching valve configured to control the direction of the first fluid discharged from the first heat exchanger, the first direction switching valve and the second direction switching valve being clustered above the second heat exchanger.

5. The manifold fluid module of claim 4, wherein the first expansion valve, first direction switching valve, second direction switching valve, and second expansion valve are arranged on the upper part of the manifold plate, the first heat exchanger is arranged on one side of the lower part of the manifold plate, and the second heat exchanger is arranged on the other side of the lower part of the manifold plate.

6. The manifold fluid module of claim 4, wherein the first heat exchanger, first expansion valve, first direction switching valve, and second direction switching valve are arranged on one side of an imaginary reference line formed on the manifold plate, and the second heat exchanger and second expansion valve are arranged on the other side.

7. The manifold fluid module of claim 4, wherein the manifold plate is divided by an imaginary reference line into a high-temperature zone where the first fluid at a high temperature flows through the first heat exchanger and a low-temperature zone where the first fluid at a low temperature flows through the second heat exchanger.

8. The manifold fluid module of claim 4, wherein the first heat exchanger comprises a first fluid port for inlet and outlet of the first fluid and a second fluid port for inlet and outlet of the second fluid, the first fluid port and the second fluid port being separately arranged.

9. The manifold fluid module of claim 8, wherein the first fluid port comprises a first inlet port where the first fluid is introduced and a first outlet port where the first fluid is discharged, the first outlet port being formed on one side close to the first expansion valve or the second expansion valve, the first outlet port being formed on the other side father away from the first expansion valve or the second expansion valve.

10. The manifold fluid module of claim 1, wherein the first heat exchanger is a water-cooled condenser, and the second heat exchanger is a chiller.

11. A manifold fluid module comprising:
a manifold plate comprising fluid passages formed internally;
a first heat exchanger coupled to the manifold plate and configured to exchange heat between a first fluid and a second fluid; and
a second heat exchanger coupled to the manifold plate configured to exchange heat between the first fluid discharged from the first heat exchanger and the second fluid,
wherein the first heat exchanger is arranged vertically, and the second heat exchanger is arranged horizontally on the manifold plate.

12. The manifold fluid module of claim 11, wherein the first heat exchanger is arranged on one side of the manifold plate, and the second heat exchanger is arranged laterally to the first heat exchanger.

13. The manifold fluid module of claim 11, further comprising:
a first expansion valve configured to expand the first fluid entering the first heat exchanger; and
a second expansion valve configured to expand the first fluid entering the second heat exchanger,
wherein the first expansion valve is arranged above the first heat exchanger, the second expansion valve is arranged above the second heat exchanger, and the first fluid entering the first and second heat exchangers moves from the top to the bottom.

14. The manifold fluid module of claim 13, further comprising a first direction switching valve and a second direction switching valve configured to control the direction of the first fluid discharged from the first heat exchanger,
wherein the first direction switching valve is arranged below the second heat exchanger, and the second direction switching valve is arranged above the second heat exchanger.

15. The manifold fluid module of claim 14, wherein the first expansion valve, the second direction switching valve, and the second expansion valve are arranged on the upper part of the manifold plate, the first heat exchanger is arranged on one side of the lower part of the manifold plate, and the second heat exchanger and the first direction switching valve are arranged on the other side of the lower part of the manifold plate.

16. The manifold fluid module of claim 14, wherein the first heat exchanger, first expansion valve, first direction switching valve, and second direction switching valve are arranged on one side of an imaginary reference line formed on the manifold plate, and the second heat exchanger and second expansion valve are arranged on the other side.

17. The manifold fluid module of claim 14, wherein the manifold plate is divided by an imaginary reference line into a high-temperature zone where the first fluid at a high temperature flows through the first heat exchanger and a low-temperature zone where the first fluid at a low temperature flows through the second heat exchanger.

18. The manifold fluid module of claim 14, wherein the first heat exchanger comprises a first fluid port for inlet and outlet of the first fluid and a second fluid port for inlet and outlet of the second fluid, the first fluid port and the second fluid port being separately arranged.

19. The manifold fluid module of claim 18, wherein the first fluid port comprises a first inlet port where the first fluid is introduced and a first outlet port where the first fluid is discharged, the first outlet port being formed on one side close to the first expansion valve or the second expansion valve, the first outlet port being formed on the other side father away from the first expansion valve or the second expansion valve.

20. The manifold fluid module of claim 11, wherein the first heat exchanger is a water-cooled condenser, and the second heat exchanger is a chiller.
